(19) United States
(12) Patent Application Publication
(10) Pub. No.: US 2010/0315900 A1
(43) Pub. Date: Dec. 16, 2010

(54) METHOD AND APPARATUS FOR HIGH RESOLUTION SOUND SPEED MEASUREMENTS

(75) Inventors: Rocco DiFoggio, Houston, TX (US); Eric B. Molz, Houston, TX (US); Anjani R. Achanta, Houston, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/796,817

(22) Filed: Jun. 9, 2010

Related U.S. Application Data
(60) Provisional application No. 61/186,542, filed on Jun. 12, 2009.

(51) Int. Cl. G01V 1/00

(52) U.S. Cl. 367/27

(57) ABSTRACT

An apparatus for estimating an influx of a formation fluid into a borehole fluid, the apparatus having: a carrier; an acoustic transducer disposed at the carrier; a first reflector disposed a first distance from the acoustic transducer and defining a first round trip distance; a second reflector disposed a second distance from the acoustic transducer and defining a second round trip distance; and a processor in communication with the acoustic transducer and configured to measure a difference between a first travel time for the acoustic signal traveling the first round trip distance and a second travel time for the acoustic signal traveling the second round trip distance to estimate the influx of the formation fluid; wherein the acoustic transducer, the first reflector, and the second reflector are disposed in the borehole fluid that is in the borehole.

### CROSS-REFERENCE TO RELATED APPLICATIONS AND PRIORITY CLAIM

This application claims the benefit of U.S. Provisional Application Ser. No. 61/186,542, entitled “METHOD AND APPARATUS FOR HIGH RESOLUTION SOUND SPEED MEASUREMENTS”, filed Jun. 12, 2009, under 35 U.S.C. §119(e), which is incorporated herein by reference in its entirety.

### BACKGROUND OF THE INVENTION

1. Field of the Invention

The present invention relates to performing sound speed measurements of a fluid disposed in a borehole penetrating the earth. More specifically, the present invention relates to estimating a gas influx into a drilling mud.

2. Description of the Related Art

Exploration and production of hydrocarbons generally requires drilling a borehole into an earth formation, which may contain a reservoir of the hydrocarbons. Drilling mud is typically pumped through a drill string to lubricate a drill bit at the distal end of the drill string. After lubricating the drill bit, the drilling mud fills the borehole. The drilling mud is usually kept under pressure to keep any fluids in the pores of the formation from escaping into the borehole. Thus, at a certain depth in the borehole, the pressure equals the pressure imposed at the surface of the borehole plus the weight of the drilling mud at that depth.

If the pressure of the drilling mud is not kept high enough, gas may escape from the pores and mix with the drilling mud. As the gas mixes with the drilling mud, the density of the drilling mud will decrease, thereby, decreasing the total pressure at a depth in the borehole.

The process of formation fluids flowing into the borehole is known as a “kick.” If the flow becomes uncontrollable, then a “blowout” occurs. During a blowout the formation, fluids can flow uncontrollably to the surface of the earth causing extensive equipment damage and/or injuries to personnel.

Therefore, what are needed are techniques to estimate an influx of formation fluid into a borehole. More particularly, it is desirable to measure the influx of gas into the borehole at small concentrations.

### BRIEF SUMMARY OF THE INVENTION

Disclosed is an apparatus for estimating an influx of a formation fluid into a borehole fluid disposed in a borehole penetrating the earth, the apparatus having: a carrier configured for being conveyed in the borehole; an acoustic transducer disposed at the carrier and configured to at least one of transmit an acoustic signal and receive a reflection of the acoustic signal; a first reflector disposed a first distance from the acoustic transducer and defining a first path having a first round trip distance; a second reflector disposed a second distance from the acoustic transducer and defining a second path having a second round trip distance; and a processor in communication with the acoustic transducer and configured to measure a difference between a first travel time for the acoustic signal traveling the first round trip distance in the borehole fluid and a second travel time for the acoustic signal traveling the second round trip distance in the borehole fluid to estimate the influx of the formation fluid; wherein the acoustic transducer, the first reflector, and the second reflector are disposed in the borehole fluid that is in the borehole.

Also disclosed is a method for estimating an influx of a formation fluid into a borehole fluid disposed in a borehole penetrating the earth, the method includes: conveying a carrier through the borehole, the carrier having an acoustic transducer, a first reflector disposed a first distance from the acoustic transducer and defining a first path having a first round trip distance, and a second reflector disposed a second distance from the acoustic transducer and defining a second path having a second round trip distance, wherein the acoustic transducer, the first reflector, and the second reflector are disposed in the borehole fluid that is in the borehole; transmitting an acoustic signal from the acoustic transducer through the borehole fluid to the first reflector and the second reflector; receiving a first reflected acoustic signal traveling the first path and a second reflected acoustic signal traveling the second path using the acoustic transducer; and measuring a difference between a first travel time for the acoustic signal traveling the first round trip distance in the borehole fluid and a second travel time for the acoustic signal traveling the second round trip distance in the borehole fluid to estimate the influx of the formation fluid.

Further disclosed is a machine-readable medium having stored thereon a program having instructions that when executed perform a method for estimating an influx of a formation fluid into a borehole fluid disposed in a borehole penetrating the earth, the method includes: transmitting an acoustic signal from an acoustic transducer through the borehole fluid to a first reflector defining a first path having a first round trip distance and a second reflector defining a second path having a second round trip distance, wherein the acoustic transducer, the first reflector, and the second reflector are disposed in the borehole fluid that is in the borehole; receiving a first reflected acoustic signal traveling the first path and a second reflected acoustic signal traveling the second path using the acoustic transducer; and measuring a difference between a first travel time for the acoustic signal traveling the first round trip distance in the borehole fluid and a second travel time for the acoustic signal traveling the second round trip distance in the borehole fluid to estimate the influx of the formation fluid.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of an acoustic logging tool disposed in a borehole penetrating the earth;

FIGS. 2A and 2B, collectively referred to as FIG. 2, depict aspects of the acoustic logging tool; and

FIG. 3 presents one example of a method for estimating an influx of a formation fluid into a borehole fluid disposed in a borehole penetrating the earth.

### DETAILED DESCRIPTION OF THE INVENTION

Disclosed are exemplary embodiments of techniques for estimating an influx of a formation fluid into a borehole fluid disposed in a borehole penetrating the earth. The techniques, which include apparatus and method, provide for high resolution acoustic measurements of the speed of an acoustic signal traveling in the borehole fluid. By detecting a change in the speed, the influx of the formation fluid into the borehole fluid can be estimated down to at least twenty-five parts per million.

The techniques use an acoustic transducer to transmit and receive an acoustic pulse (i.e., the acoustic signal) through the borehole fluid. Because the acoustic pulse generated by the acoustic transducer can vary slightly from one firing to another firing, the techniques disclose directing a portion of the acoustic pulse towards a near reflector and another portion of the same acoustic pulse towards a far reflector. Good correlations between received waveforms of the acoustic pulse reflected from the near and far reflectors are obtained, in part, because there are no variations in the original firing-pulse waveform for the two reflected waveforms. In one embodiment, the acoustic transducer, the near reflector, and the far reflector are disposed in a logging tool that is conveyed through the borehole filled with the borehole fluid.

A cross correlation between reflected acoustic signals from the near reflector and the far reflector provide the difference in round trip travel time. The cross correlation maximum between the two reflected waveforms is the round trip travel time. The difference in round trip distance for the two reflected waveforms is twice the distance between the near reflector and the far reflector. The speed of the acoustic signal is calculated from the difference in the round trip distance divided by the difference in round trip travel times for the two reflected waveforms.

To improve the cross correlation, speed data can be collected at equally spaced time intervals (or channels) that are very closely spaced in time. The closely spaced time intervals provide for higher resolution acoustic speed measurements. Higher time resolution permits detection of correspondingly smaller amounts of gas influx.

For convenience, certain definitions are now presented. The term “acoustic signal” relates to the pressure amplitude versus time of a sound wave or an acoustic wave traveling in a medium that allows propagation of such waves. In one embodiment, the acoustic signal can be a pulse. The term “acoustic transducer” relates to a device for transmitting (i.e., generating) an acoustic signal or receiving an acoustic signal. When receiving the acoustic signal in one embodiment, the acoustic transducer converts the energy of the acoustic signal into electrical energy. The electrical energy has a waveform that is related to a waveform of the acoustic signal.

The term “cross correlation” relates to a measure of how closely two signals resemble each other as a function of time shift. For two digitized waveforms having the same time spacing, the cross correlation associated with a particular time shift is the dot product of the first digitized waveform with the time shifted version of the second digitized waveform. When calculated for a series of time shifts, the maximum cross correlation occurs for that time shift at which the two waveforms most resemble each other, which means that the maximum cross correlation is the time shift that is equal to the travel time associated with the difference in distance (between the near and far reflectors) that was traveled by the two waveforms. Thus, the maximum cross correlation is used to calculate the speed of the acoustic signal from distance divided by time. To achieve travel time resolution that is better than the time channel spacing, polynomial fitting (such as Savitzky-Golay techniques) can be used on the cross correlation function over the neighborhood of the maximum. In this way, a truer function maximum can be interpolated from the interpolated zero crossing of the first derivative of the polynomial fit to the cross correlation function.

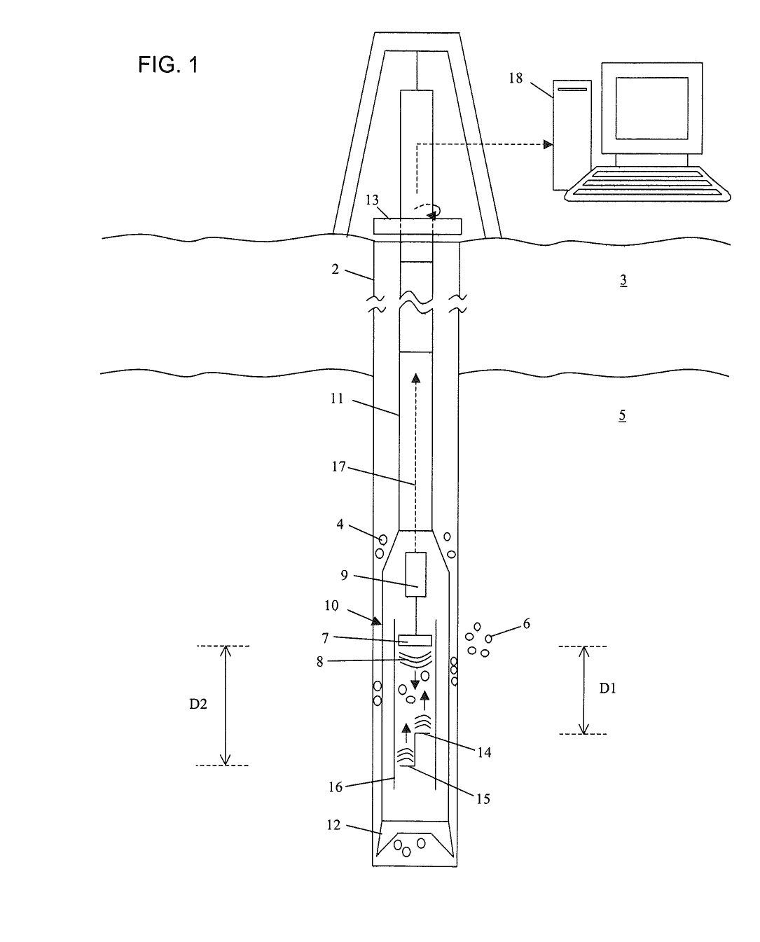

Reference may now be had to FIG. 1. FIG. 1 illustrates an exemplary embodiment of an acoustic logging tool 10 disposed in a borehole 2 penetrating the earth 3. The borehole 2 contains a borehole fluid 4, which is generally drilling mud. The earth 3 includes a formation 5 that has pores, which can contain a formation fluid 6. The logging tool 10 in the embodiment of FIG. 1 is disposed at a drill string 11 having a drill bit 12. The drill string 11 is rotated by a motor 13 for drilling the borehole 2.

Still referring to FIG. 1, the logging tool 10 includes an acoustic transducer 7 configured to transmit and receive an acoustic signal 8. The logging tool 10 also includes a first reflector 14 spaced a first distance D1 from the acoustic transducer 7 and a second reflector 15 spaced a second distance D2 from the transducer 7. In the embodiment of FIG. 1, the second distance D2 is greater than the first distance D1.

Still referring to FIG. 1, the acoustic transducer 7, the first reflector 14, and the second reflector 15 are disposed in a groove 16 in the drill string 11. The groove 16 allows the borehole fluid 4 to flow between the acoustic transducer 7 and the reflectors 14 and 15 so that measurements of the speed of the acoustic signal 8 can be performed on the borehole fluid 4 at the depth of the logging tool 10. The groove 16 also protects the transducer 7 and the reflectors 14 and 15 from contact with the wall of the borehole 2.

The first reflector 14 reflects a portion of the acoustic signal 8 back to the acoustic transducer 7 such that the portion makes a round trip from the transducer 7 to the first reflector 14 and back to the transducer 7. The roundtrip distance of this portion of the acoustic signal 8 defines a first path. Similarly, another portion of the acoustic signal 8 makes a round trip from the transducer 7 to the second reflector 15 and back to the transducer 7. The round trip distance of this other portion of the acoustic signal 8 defines a second path.

The speed of the acoustic signal 8 can be calculated by dividing the difference in round trip distance (2*(D1−D2) for round trip) by the difference in round trip travel time (T2−T1, where T1 and T2 are the travel times for the acoustic signal 8 traveling the first path and the second path respectively). The difference in the round trip distance may also be stated as the distance of the second path minus the distance of the first path. This two reflector approach allows cross correlation to be done on two reflected waveforms that were generated by the same acoustic pulse, which, when making very high resolution (10-25 ppm) measurements, limits or eliminates any uncertainties due to waveform variations from one acoustic pulse to another acoustic pulse.

Still referring to FIG. 1, an electronic unit 9 is coupled to the acoustic transducer 7. The electronic unit 9 can be used to operate the logging tool 10 and/or process data associated with measurements of the speed of the acoustic wave 8. The data can also be transmitted as a data signal 17 to a processing system 18 at the surface of the earth 3. The processed data can be used to determine if an influx of a formation fluid such as a gas is occurring. The processed data can be provided to an operator. Based on the processed data, the operator can make drilling decisions that can prevent a kick or blowout from occurring. Communication of the data with processing system 18 can be via wired drilling pipe or pulsed mud as non-limiting examples.

While the embodiment of FIG. 1 teaches a measurement-while-drilling (MWD) application, the techniques are equally suited for use in wireline applications and in open-borehole and cased borehole applications.

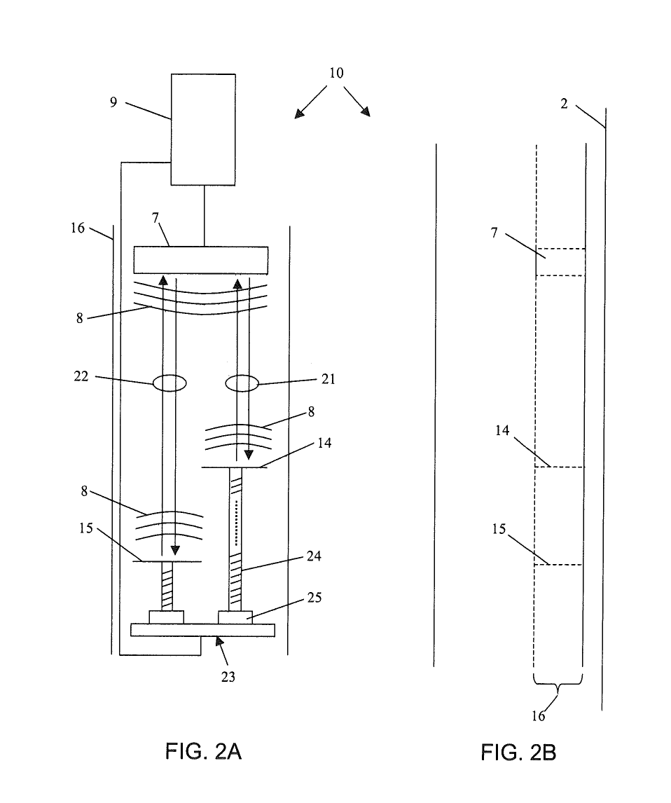

Reference may now be had to FIG. 2. FIG. 2 depicts aspects of the acoustic logging tool 10. Shown in FIG. 2A are embodiments of a first path 21 that the acoustic signal 8 follows between the acoustic transducer 7 and the first reflector 14 and a second path 22 that the acoustic signal 8 follows between the transducer 7 and the second reflector 15.

Still referring to FIG. 2A, the first path 21 and the second path 22 can be adjusted using an adjustment device 23. In the embodiment of FIG. 2, the adjustment device 23 is coupled to the first reflector 14 and the second reflector 15. These adjustments allow the same apparatus to be used in drilling fluids that have very different acoustic attenuation. A shorter first path 21 and second path 22 would be used for more attenuating drilling fluids, which are usually those that have more suspended solids and therefore have higher mass density. The higher mass density drilling fluids are generally used in deeper and/or higher pressure wells. During measurements, the distance difference D2−D1 is fixed and known. In another embodiment, the adjustment device 23 can be coupled to the acoustic transducer 7. The adjustment device 23 includes an adjustment screw 24 coupled to a motor 25 for each of the first reflector 14 and the second reflector 15. In one embodiment, the distance between the transducer 7 and the reflectors 14 and 15 can be reduced when the borehole fluid 4 is highly attenuating to the acoustic signal 8. In addition, the distance or step between the first reflector 14 and the second reflector 15 can be increased to improve cross correlation of the two reflected acoustic signals for a given borehole drilling fluid attenuation.

FIG. 2B illustrates a side view of the acoustic logging tool 10. Specifically, FIG. 2B shows the acoustic transducer 7, the first reflector 14 and the second reflector 15 disposed in the groove 16 to protect these components from contact with the wall of the borehole 2. The groove 16 is open to the borehole environment to allow the borehole fluid 4 to flow into the groove 16 and between these components.

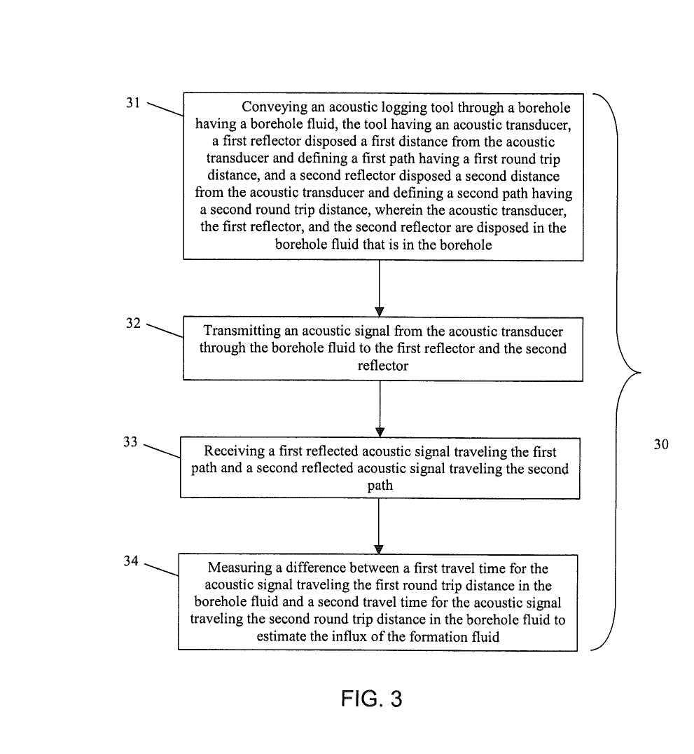

FIG. 3 presents one example of a method 30 for estimating an influx of the formation fluid 6 into the borehole fluid 4 disposed in the borehole 2 penetrating the earth 3. The method 30 calls for (step 31) conveying the acoustic logging tool 10 through the borehole 2. Further, the method 30 calls for (step 32) transmitting the acoustic signal 8 from the acoustic transducer 7 through the borehole fluid 5 to the first reflector 14 and the second reflector 15. Further, the method 3 calls for (step 33) receiving the acoustic signal 8 traveling the first path 21 and the acoustic signal 8 traveling the second path 22 using the acoustic transducer 7. Further, the method 30 calls for (step 34) measuring a difference between a first travel time for the acoustic signal traveling the first round trip distance in the borehole fluid and a second travel time for the acoustic signal traveling the second round trip distance in the borehole fluid to estimate the influx of the formation fluid. The method 30 can also include comparing a current measurement of speed of the acoustic signal 8 to a previous measurement of speed of the acoustic signal 8 to determine any sudden change in the speed that will indicate the influx of gas into the borehole 2.

The cross correlation between the waveforms of the two reflected acoustic signals can be improved further by using Savitzky-Golay interpolation techniques that allow sub-channel time resolution that provides four or more times finer resolution than the nearest whole channel resolution. The Savitzky-Golay interpolation techniques perform a local polynomial regression on a distribution of equally spaced points (e.g., the equally spaced channels or time intervals) to determine the smoothed value for each point. The Savitzky-Golay method provides interpolations that improve resolution while reducing noise from the acoustic signal 8 received by the acoustic transducer 7. The Savitzky-Golay method is presented in detail in Savitzky and Golay, Analytical Chemistry, Vol. 36, No. 8, July 1964.

Precision in determining the speed of the acoustic wave 8 can be improved in at least two ways. One way is to over-sample the waveforms of the reflected acoustic signal 8. In one embodiment, one hundred samples are taken per full wave such that a 250 KHz acoustic signal would be sampled at 25 MHz. Another way to improve precision is by “stacking” or averaging received waveform data over the equally spaced channels. In one example, the data is stacked from 16 to 256 channels to remove timing variations from firing one acoustic pulse to another acoustic pulse.

In the embodiments presented above, the acoustic signal 8 is transmitted and received by one acoustic transducer 7. In other embodiments, one or more acoustic transducers 7 can be used to transmit the acoustic signal 8. Similarly, one or more acoustic transducers 7 can be used to receive the acoustic signal 8 reflected from the reflectors 14 and 15.

The term “carrier” as used herein means any device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

In support of the teachings herein, various analysis components may be used, including a digital and/or an analog system. For example, the digital and/or analog system can be included in the electronic unit 9 or the processing system 18. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a mounting bracket, power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating an influx of a formation fluid into a borehole fluid disposed in a borehole penetrating the earth, the apparatus comprising:
a carrier configured for being conveyed in the borehole;
an acoustic transducer disposed at the carrier and configured to at least one of transmit an acoustic signal and receive a reflection of the acoustic signal;
a first reflector disposed a first distance from the acoustic transducer and defining a first path having a first round trip distance;
a second reflector disposed a second distance from the acoustic transducer and defining a second path having a second round trip distance; and
a processor in communication with the acoustic transducer and configured to measure a difference between a first travel time for the acoustic signal traveling the first round trip distance in the borehole fluid and a second travel time for the acoustic signal traveling the second round trip distance in the borehole fluid to estimate the influx of the formation fluid;
wherein the acoustic transducer, the first reflector, and the second reflector are disposed in the borehole fluid that is in the borehole.

2. The apparatus of claim 1, wherein the processor calculates a speed of the acoustic signal by dividing a difference between the first round trip distance and the second round trip distance by the difference between the first travel time and the second travel time.

3. The apparatus of claim 2, wherein the processor is configured to estimate the influx of the formation fluid from the speed of the acoustic signal.

4. The apparatus of claim 2, wherein the formation fluid is a gas and the processor is configured to indicate the influx of the gas from a decrease in the speed of the acoustic signal.

5. The apparatus of claim 1, wherein the processor is configured to perform a cross correlation between a first waveform of the acoustic signal traveling the first path and a second waveform of the acoustic signal traveling the second path to determine the difference between the first travel time and the second travel time, the waveforms being received by the acoustic transducer.

6. The apparatus of claim 5, wherein the difference between the first travel time and the second travel time is determined from a maxima of the cross correlation.

7. The apparatus of claim 5, wherein the processor is configured to measure the first waveform and the second waveform at equally spaced time intervals.

8. The apparatus of claim 7, wherein the equally spaced time intervals are small enough so that resolution of the speed of the acoustic signal is sufficient for a desired minimum detectable influx of the formation fluid.

9. The apparatus of claim 7, wherein the processor is configured to interpolate between a best correlating time shift between the first waveform and the second waveform using a Savitzky-Golay interpolation technique.

10. The apparatus of claim 1, wherein the acoustic transducer, the first reflector, and the second reflector are disposed in a groove in the carrier.

11. The apparatus of claim 1, wherein the carrier is conveyed by at least one of a wireline, a slickline, coiled tubing, and a drill string.

12. The apparatus of claim 1, further comprising an adjustment device configured to adjust a distance of at least one of the first path and the second path.

13. The apparatus of claim 1, wherein the borehole fluid comprises drilling mud.

14. A method for estimating an influx of a formation fluid into a borehole fluid disposed in a borehole penetrating the earth, the method comprising:
conveying a carrier through the borehole, the carrier comprising an acoustic transducer, a first reflector disposed a first distance from the acoustic transducer and defining a first path having a first round trip distance, and a second reflector disposed a second distance from the acoustic transducer and defining a second path having a second round trip distance, wherein the acoustic transducer, the first reflector, and the second reflector are disposed in the borehole fluid that is in the borehole;
transmitting an acoustic signal from the acoustic transducer through the borehole fluid to the first reflector and the second reflector;
receiving a first reflected acoustic signal traveling the first path and a second reflected acoustic signal traveling the second path using the acoustic transducer; and
measuring a difference between a first travel time for the acoustic signal traveling the first round trip distance in the borehole fluid and a second travel time for the acoustic signal traveling the second round trip distance in the borehole fluid to estimate the influx of the formation fluid.

15. The method of claim 14, further comprising calculating a speed of the acoustic signal by dividing a difference between the first round trip distance and the second round trip distance by the difference between the first travel time and the second travel time.

16. The method of claim 15, wherein measuring comprises cross correlating between a first waveform of the acoustic signal traveling the first path and a second waveform of the acoustic signal traveling the second path to determine the difference between the first travel time and the second travel time, the waveforms being received by the acoustic transducer.

17. The method of claim 16, further comprising measuring the first waveform and the second waveform at equally spaced time intervals.

18. The method of claim 17, wherein the equally spaced time intervals are small enough so that resolution of the difference between the first travel time and the second travel time is sufficient for a desired minimum detectable influx of the formation fluid.

19. The method of claim 17, further comprising interpolating between a best correlating time shift between the first waveform and the second waveform using a Savitzky-Golay interpolation technique.

20. The method of claim 14, further comprising adjusting at least one of the first path to improve the receiving of the first reflected acoustic signal and the second path to improve the receiving of the second reflected acoustic signal.

21. A machine-readable medium having stored thereon a program comprising instructions that when executed perform a method for estimating an influx of a formation fluid into a borehole fluid disposed in a borehole penetrating the earth, the method comprising:
transmitting an acoustic signal from an acoustic transducer through the borehole fluid to a first reflector defining a first path having a first round trip distance and a second reflector defining a second path having a second round trip distance, wherein the acoustic transducer, the first reflector, and the second reflector are disposed in the borehole fluid that is in the borehole;
receiving a first reflected acoustic signal traveling the first path and a second reflected acoustic signal traveling the second path using the acoustic transducer; and
measuring a difference between a first travel time for the acoustic signal traveling the first round trip distance in the borehole fluid and a second travel time for the acoustic signal traveling the second round trip distance in the borehole fluid to estimate the influx of the formation fluid.
